(19) United States
(12) Patent Application Publication
(10) Pub. No.: US 2010/0259730 A1
(43) Pub. Date: Oct. 14, 2010

(54) PORTABLE PROJECTOR

(75) Inventors: KIM-YEUNG SIP, Shenzhen City (CN); WEN-YAN YANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/485,940

(22) Filed: Jun. 17, 2009

(30) Foreign Application Priority Data
Apr. 8, 2009 (CN) 200910301421.7

(51) Int. Cl. G03B 21/28

(52) U.S. Cl. 353/98

(57) ABSTRACT

A portable projector includes a housing, a reflecting unit, and a projecting unit. The reflecting unit includes a foldable cover rotatably hinged to the housing, and a reflector fixed on the foldable cover. The projecting unit is received in the housing, and is directed at the reflecting unit, and is configured for projecting an image to a projection screen via the image being reflected off by the reflector.

### BACKGROUND

1. Technical Field

The present disclosure relates to a portable projector.

2. Description of Related Art

Current portable electronic devices, such as personal digital assistants (PDAs) or mobile phones, provide image projection functionality and can be used as portable projectors in conference rooms or home theatres. Such a portable projector is generally installed on the side of the portable electronic devices and is exposed to the exterior environment whether in use or not. Thus, dusts and other contaminations may degrade the lens and the lens holder of the portable projector and cause poor performance.

Therefore, what is desired is a portable projector that can overcome the described limitations.

### BRIEF DESCRIPTION OF THE DRAWINGS

FIG. 1 is an assembled, isometric view of a portable projector which includes a reflecting assembly, according to an exemplary embodiment.

FIG. 2 is an isometric view of the reflecting assembly of FIG. 1.

FIG. 3 is an exploded, isometric, partially sectional view of the portable projector of FIG. 1.

FIG. 4 is an isometric, schematic view of the portable projector, which is in a first operation state, according to an exemplary embodiment.

FIG. 5 is an isometric, schematic view of the portable projector, which is in a second operation state, according to an exemplary embodiment.

### DETAILED DESCRIPTION

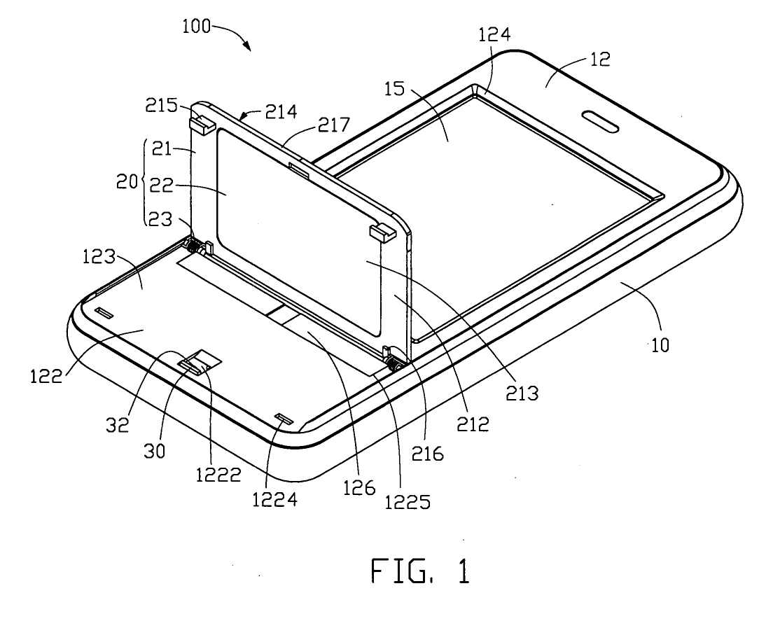

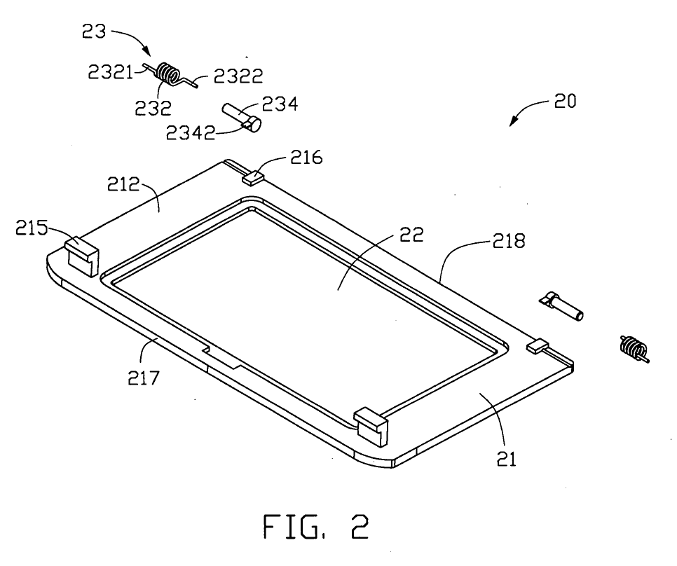

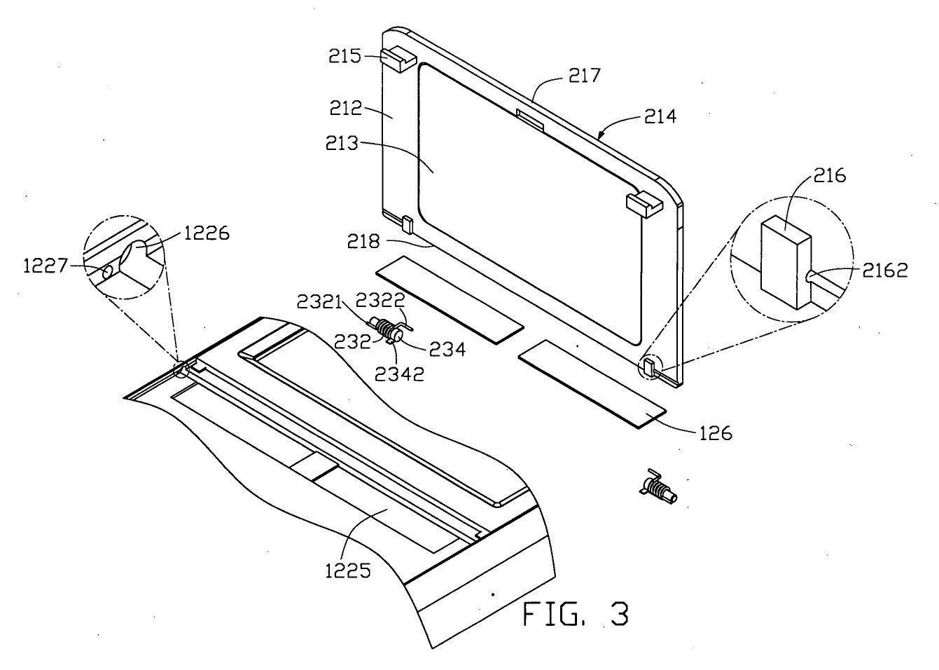

Referring to FIGS. 1-3, a portable projector 100 in accordance with an exemplary embodiment is illustrated. The portable projector 100 can be, but is not limited to, a mobile phone or a personal digital assistant (PDA). The portable projector 100 includes a housing 10, a display 15, a reflecting unit 20, and a projecting unit 30.

The housing 10 is a hollow cuboid in shape, and includes a front surface 12. The housing 10 defines a cavity 122 in one end of the front surface 12 and a first opening 124 in the middle of the front surface 12. The cavity 122 and the first opening 124 are adjacent to each other.

The cavity 122 defines a rectangular bottom surface 123. In particular, the length-side of the bottom surface 123 is substantially perpendicular to the length-side of the front surface 12. The housing 10 also defines a second opening 1222 in the bottom surface 123 close to a longer edge of the bottom surface 123 away from the first opening 124. Furthermore, the housing 10 also defines two slots 1224 in the bottom surface 123 close to the longer edge of the bottom surface 123 away from the first opening 124. In particular, the second opening 1222 is positioned generally at the middle of the longer edge of the bottom surface 123. The two slots 1224 are positioned, generally, close to the two ends of the longer edge of the bottom surface 123 and are substantially symmetrical with each other about the second opening 1222. In addition, the housing 10 further defines two first receiving portions 1225 in the bottom surface 123 close to the longer edge of the bottom surface 123 which is close to the first opening 124. The housing 10 further includes two pressing plates 126 mating with the two first receiving portions 1225 in shape. Furthermore, the housing 10 defines a threaded hole 1226 in each of two short sidewalls of the cavity 122 and a first receiving hole 1227 adjacent to the threaded hole 1226.

The reflecting unit 20 includes a foldable cover 21, a reflector 22, and a rotatable assembly 23.

The foldable cover 21 is a rectangular sheet, and shaped corresponding to the cavity 122. The foldable cover 21 includes a first surface 212 and a second surface 214 facing away from the first surface 212. The foldable cover 21 defines a third opening 213 through the first surface 212 and the second surface 214. The foldable cover 21 further includes a first end 217 and a second end 218 opposite to the first end 217, and two hooks 215. The two hooks 215 are integrally formed with the foldable cover 21 on the first surface 212 at the first end 217. The positions of the hooks 215 on the first surface 212 correspond to the positions of the two slots 1224 on the bottom surface 123. The hooks 215 are made from flexible material, for example, silicone. Furthermore, the foldable cover 21 includes two restricting plates 216 perpendicularly extended outward from the first surface 212 at the second end 218. Each of the restricting plates 216 defines a second receiving hole 2162.

It should be mentioned that the foldable cover 21 is not limited by this description, in alternative embodiments, the two hooks 215 and the two restricting plates 216 may be separately formed. The two hooks 215 can be attached to the first end 217 by adhesive, welding (e.g., plastic welding), or other attaching methods. The two restricting plates 216 can be attached to the second end by adhesive, welding (e.g., plastic welding), or other attaching methods.

The reflector 22 can be a convex mirror, a concave mirror or a plane mirror. The reflector 22 is accommodated in the third opening 213.

The rotatable assembly 23 includes two torsion coil springs 232 and two screws 234 mating with the two threaded holes 1226. Each of the torsion coil springs 232 includes a first connecting distal end 2321 and a second connecting distal end 2322. Each of the screws 234 includes a block 2342 radially extended outward from the outer sidewall of the corresponding screw 234. In this embodiment, the total thickness of the block 2342 and the pressing plate 126 is substantially equal to the depth of the first receiving portion 1225.

In this embodiment, the projecting unit 30 includes a projecting lens 32. The projecting lens 32 protrudes out of the housing 20 via the second opening 1222.

In assembly, the display 15 is received in the first opening 124. The two torsion coil springs 232 are respectively coiled around the two screws 234. The two screws 234 are inserted into and engaged with the threaded holes 1226 correspondingly. The first connecting distal ends 2321 are inserted into the first receiving holes 1227 correspondingly. Next, the pressing plate 126 is fixedly buried into the first receiving portions 1225 with the blocks 2342 interposed therebetween. The second connecting distal end 2322 of the torsion coil spring 232 is inserted into the second receiving hole 2162 of the restricting plates 216 of the foldable cover 21. Therefore, the foldable cover 21 is rotatably hinged to the housing 10 and can be folded into the cavity 122 or unfolded away from the cavity 122.

It should be mentioned that the portable projector 100 is not limited by this embodiment. In alternative embodiments, the foldable cover 21 can also hinge to the housing 10 via other methods, as long as the foldable cover 21 can be rotated relative to the housing 10.

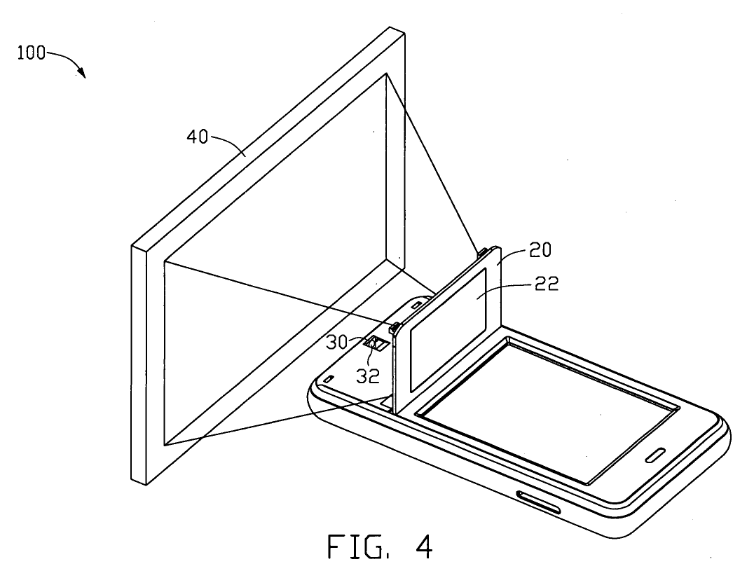

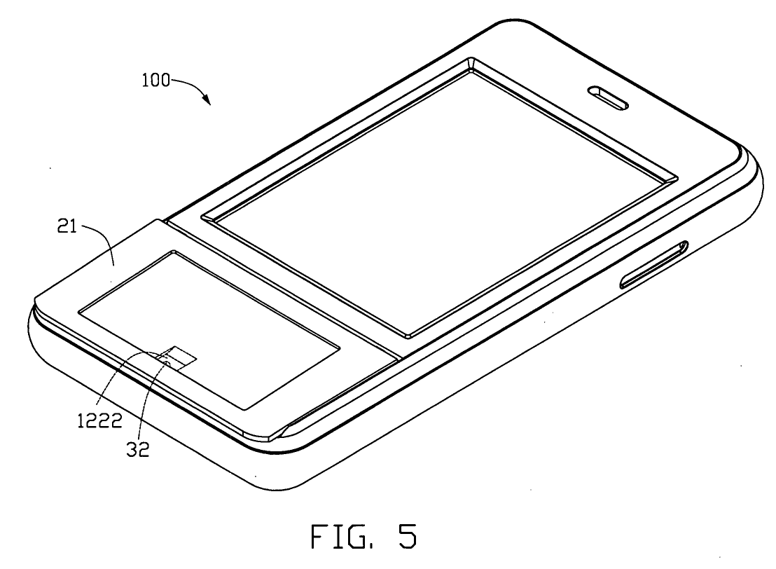

Referring to FIGS. 4-5, in use, the foldable cover 21 is unfolded, and the foldable cover 21 is substantially perpendicular to the cavity 122, and the projecting lens 32 protrudes out of the housing 10 via the second opening 1222 towards the reflecting unit 20. The projected light generated by the projecting unit 30 impinges onto the reflector 22. The viewing filed is aligned with the reflector 22, and the projection range is substantially equal to or slightly smaller than the size of the reflector 22. The projected light is reflected onto a projection screen 40 via the reflector 22. When users do not use the projecting function, the projecting unit 30 is drawn back into the housing 10 via the second opening 1222, and the foldable cover 21 is fittingly received in the cavity 122 by the two hooks 215 hooking to the two slots 1224. As a result, the second opening 1222 is coved by the foldable cover 21, and the portable projector 100 is capable of preventing the projecting unit 30 from being exposing to the exterior when not in use thereby preventing degradation or from being physically damaged.

It will be understood that the above particular embodiments and methods are shown and described by way of illustration only. The principles and the features of the disclosure may be employed in various and numerous embodiments thereof without departing from the scope of the invention as claimed. The described embodiments illustrate but do not restricting the scope of the invention.

What is claimed is:

1. A portable projector, comprising:
a housing;
a reflecting unit comprising a foldable cover rotatably hinged to the housing, and a reflector fixed on the foldable cover; and
a projecting unit received in the housing, and directed at the reflecting unit, and configured for projecting an image to a projection screen via the image being reflected off by the reflector.

2. The portable projector as claimed in claim 1, wherein the reflecting unit further comprises a rotatable assembly; and the foldable cover is rotatably hinged to the housing via the rotatable assembly.

3. The portable projector as claimed in claim 2, further comprising a display, wherein the housing is a hollow cuboid in shape, and comprises a front surface; the housing defines a cavity in one end of the front surface and a first opening in the middle of the front surface; the cavity and the first opening are adjacent to each other; the cavity comprises a rectangular bottom surface; and the housing defines a second opening in the bottom surface close to a longer edge of the bottom surface away from the first opening, for receiving the projecting unit.

4. The portable projector as claimed in claim 3, wherein the foldable cover comprises a first surface facing the cavity; and a second surface facing away from the first surface; and the foldable cover defines a third opening through the first surface and the second surface for accommodating the reflector.

5. The portable projector as claimed in claim 4, wherein the housing defines two slots in the bottom surface close to the longer edge of the bottom surface away from the first opening; the two slots are positioned generally at two ends of the longer edge of the bottom surface and are substantially symmetrical with each other about the second opening; the foldable cover comprises two hooks, a first end, and second end opposite to the first end; the two hooks are formed on the first end of the foldable cover on the first surface; and are made from flexibility material; the positions of the hooks on the first surface correspond to the positions of the slots on the bottom surface; and the foldable cover is fittingly received in the cavity by the two hooks hooking to the two slots.

6. The portable projector as claimed in claim 5, wherein the housing further defines two first receiving portions in the bottom surface close to a longer edge of the bottom surface which is close to the first opening, the housing further comprises two pressing plates mating with the two first receiving portions; each of two short sidewalls of the cavity defines a threaded hole and a first receiving hole adjacent to the threaded hole; the rotatable assembly comprises two torsion coil springs and two screws mated with the two threaded holes; each of the torsion coil springs comprises a first connecting distal end and a second connecting distal end; each of the screws comprises a block radially extended outward from the outer sidewall of the corresponding screw; the torsion coil spring coils are around the two screws, and the two screws are inserted into and engaged with the threaded hole; the first connecting distal end inserts through the first receiving hole; the pressing plate is fixedly buried into the first receiving portions with the blocks interposed therebetween; the foldable cover comprises two restricting plates, each of the restricting plates defines a second receiving hole, the second connecting distal end of the torsion coil spring inserts through one corresponding of the second receiving holes of the restricting platess of the foldable cover.

7. The portable projector as claimed in claim 6, wherein the total thickness of the block and the pressing plate is substantially equal to the depth of the first receiving portion.

8. The portable projector as claimed in claim 1, wherein the portable projector is a mobile phone or a personal digital assistant.
